(19) United States
(12) Patent Application Publication
(10) Pub. No.: US 2018/0150931 A1
(43) Pub. Date: May 31, 2018

(54) SCREEN ZOOM FEATURE FOR AUGMENTED REALITY APPLICATIONS

(71) Applicant: Caterpillar Inc., Peoria, IL (US)

(72) Inventors: James Edward WAGNER, Chillicothe, IL (US); Shadi Naji KFOUF, Peoria, IL (US)

(73) Assignee: Caterpillar Inc., Peoria, IL (US)

(21) Appl. No.: 15/362,985

(22) Filed: Nov. 29, 2016

(51) Int. Cl. G06T 3/40; G06T 19/00; G06F 3/01; G06T 7/00

(52) U.S. Cl. CPC G06T 3/40; G06T 19/006; G06T 7/003; G06T 7/0004; G06F 3/017

(57) ABSTRACT

A computing device has a CPU and a digital camera configured to capture a digital image of a portion of a machine and send the digital image to the CPU for processing. An interactive display of the computing device renders the digital image. An augmented reality processing module detects a target point located on the machine and appearing within the digital image, generates an augmented reality image including information relevant to the portion of the machine included in the digital image, determines a position and orientation of the augmented reality image relative to the target point, and overlays the augmented reality image on the digital image relative to the target point in a relationship based on the determined position and orientation. A user gesture processing module associated with the interactive display simultaneously selects a corresponding magnification of the digital image and overlaid augmented reality image displayed on the interactive display based on a user gesture relative to the interactive display.

### TECHNICAL FIELD

The present disclosure relates generally to a screen zoom feature, and more particularly, to a screen zoom feature for augmented reality applications.

### BACKGROUND

Conventional augmented reality applications provide a live view of a real-world environment whose elements may be augmented by computer-generated sensory input such as video, sound, graphics or GPS data. With such applications, a view of reality may be modified by a computing device, and an augmented reality can be superimposed over top of an actual digital image in order to enhance a user's perception of reality and provide more information about the user's environment or the object being viewed in the digital image. For example, augmented contents may be applied in real-time and in context with features of a machine or other object being viewed in the digital image. With the proliferation of mobile devices, such as smart phones, information about the surrounding real world of a user may be displayed on a mobile device with additional augmented contents, such as artificial information about the environment with virtual objects being overlaid on the real-world objects.

The conventional augmented reality applications may be improved by identifying and providing interactions between tangible real-world objects and augmented reality objects, which may assist a user in evaluating the real-world object and making decisions based at least in part on the augmented information. In addition, the conventional augmented reality applications may be improved by enabling users to interact with the tangible and virtual environments with user-defined interfaces. Therefore, there is a need for a method, computing device, and augmented reality enabled computing device that can improve the conventional augmented reality applications. One method of using a virtual or augmented reality image to enhance visibility or perception of objects is described in U.S. Pat. No. 9,304,319 (the '319 patent) issued to Bar-Zeev et al. on Apr. 5, 2016. The '319 patent describes an augmented reality system that purports to improve focus of real and virtual objects. The system disclosed in the '319 patent includes a see-through display and a microdisplay assembly attached to the see-through display device that generates a virtual object for display in the user's current focal region.

Although the system of the '319 patent may employ virtual images to enhance visibility or perception of objects, improving a user's ability to perceive or focus on the object, the disclosed system does not overlay an augmented reality image on a digital image of an object being rendered on an interactive display and allow the user to simultaneously change magnification of both the digital image and the augmented reality image by gestures relative to the interactive display.

The disclosed computing device is directed to overcoming one or more of the problems set forth above and/or other problems in the art.

### SUMMARY OF THE INVENTION

In one aspect, the present disclosure is directed to a computing device configured for use during inspection and maintenance of a machine. The computing device may include a central processing unit (CPU), and a digital camera coupled with the CPU and configured to capture a digital image of at least a portion of the machine and send the digital image to the CPU for processing. The computing device may also include an interactive display communicatively coupled with the digital camera and the CPU and configured to render the digital image, and an augmented reality processing module communicatively coupled with the CPU and the interactive display. The augmented reality processing module may be configured to detect a target point located on the machine and appearing within the digital image, generate an augmented reality image including information relevant to the portion of the machine included in the digital image, determine a position and orientation of the augmented reality image relative to the target point, and overlay the augmented reality image on the digital image relative to the target point in a relationship based on the determined position and orientation. The computing device may still further include a user gesture processing module associated with the interactive display and configured to select a corresponding magnification of the digital image and the overlaid augmented reality image displayed on the interactive display based on a user gesture relative to the interactive display while maintaining the relationship between the digital image and the augmented reality image.

In another aspect, the present disclosure is directed to a client computing device including an interactive display, a digital camera communicatively coupled with the interactive display, at least one processor, and at least one memory including computer program code for one or more programs. The at least one memory and the computer program code are configured to, with the at least one processor, cause the client computing device to display a digital image of at least a portion of a product on the interactive display, zoom in and zoom out on the digital image based on gestures of a user relative to the interactive display, generate an augmented reality image including information relevant to and aligned with specific locations on the digital image, and overlay the augmented reality image on the digital image. The at least one memory and the computer program code are also configured to, with the at least one processor, maintain alignment between the digital image and the information of the augmented reality image and correlate magnification of the digital image with magnification of the augmented reality image while a user zooms in and out on the digital image of the product using the gestures relative to the interactive display.

In yet another aspect, the present disclosure is directed to a method of inspecting and maintaining a machine using a computing device, in which the computing device includes an interactive display, a digital camera communicatively coupled with the interactive display, at least one processor, and at least one memory including computer program code for one or more programs. The method includes the at least one processor retrieving stored information from the at least one memory and using the stored information along with the computer program code to cause the computing device to display a digital image of at least a portion of the machine on the interactive display, zoom in and zoom out on the digital image based on gestures of a user relative to the interactive display, generate an augmented reality image including information relevant to and aligned with specific locations on the digital image, and overlay the augmented reality image on the digital image. The method further includes the at least one processor causing the computing device to maintain alignment between the digital image and the information of the augmented reality image and correlate magnification of the digital image with magnification of the augmented reality image while a user zooms in and out on the digital image of the machine using the gestures relative to the interactive display.

### BRIEF DESCRIPTION OF THE DRAWINGS

FIG. 1 is a schematic illustration of an interactive display of an exemplary disclosed computing device;

FIG. 2 is a schematic illustration of the interactive display of FIG. 1 at a different magnification;

FIG. 3 is a schematic illustration of an exemplary disclosed portable computing device; and

FIG. 4 is a flow chart illustrating an exemplary disclosed method of operating the computing device of FIGS. 1-3.

### DETAILED DESCRIPTION

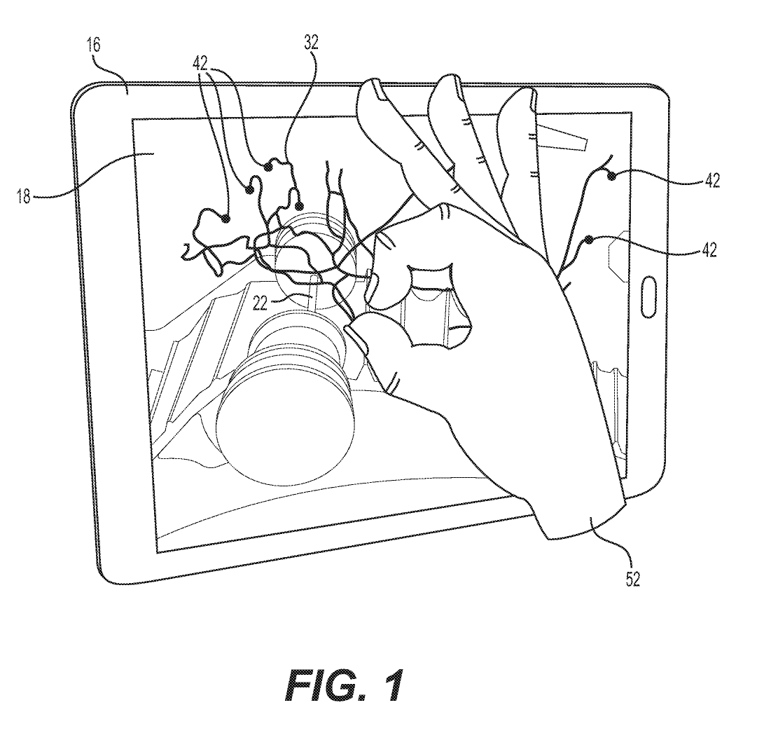

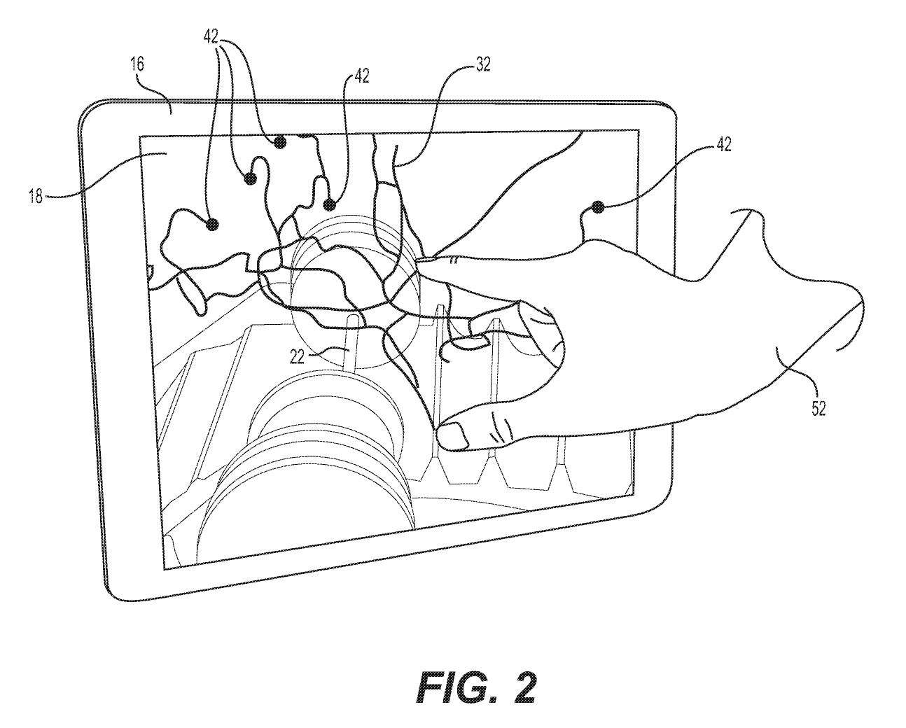

FIGS. 1-3 illustrate an exemplary computing device 16, 350 according to this disclosure. The disclosed computing device may be a tablet, as shown, or any of a variety of other portable computing devices with a touch-sensitive display, such as a smartphone, a wearable computing system such as a head-mounted display, a laptop computer, and a personal digital assistant. In various exemplary implementations of this disclosure, the computing device may be used to facilitate the inspection, maintenance, and servicing of a machine, a system, or other object. FIGS. 1 and 2 illustrate a user 52 interacting with an interactive display 18 on a portable computing device 16. User gestures, such as pinching two fingers together and moving the two fingers apart while in contact with or in close proximity to a touch-sensitive screen on the interactive display 18 cause a change in the magnification of a digital image rendered on the screen. In the exemplary embodiment of FIGS. 1 and 2, a digital image of a portion of a machine 22 is captured by a digital camera included on the device 16. The digital image is processed by one or more processors and rendered on the interactive display screen 18 of the computing device 16.

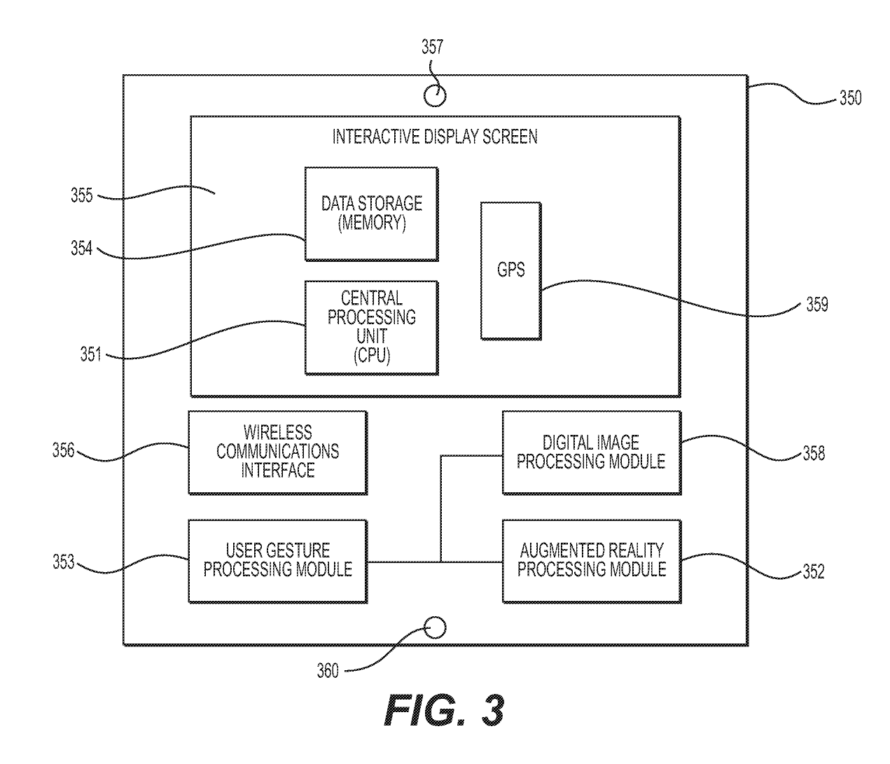

As shown in the exemplary schematic of FIG. 3, a portable computing device 350 may include one or more front facing cameras 357 as well as one or more backwards facing cameras. Backwards facing cameras may detect a direction a user is gazing based on light reflected from the user's retina and use this information to adjust the focal length and/or direction of the front facing cameras.

As shown in FIG. 3, an exemplary embodiment of a portable computing device 350 according to this disclosure may be configured to include at least one digital camera 357, one or more input devices 360, and an interactive display screen 355. Input devices 360 may include a microphone, touch pad, input port, and ethernet connection, among other possibilities. The interactive display screen 355 may include one or more portions of the screen or the entire screen being configured to sense user gestures, such as at least one of pressure, position, movement, and relative movement of one or more fingers via capacitive sensing, resistance sensing, or a surface acoustic wave process, among other possibilities. In some embodiments the interactive display screen 355 may be capable of sensing movement of two fingers simultaneously, such as the pinching of two fingers together and moving the two fingers apart. The interactive display screen 355 may also be configured to sense movement in a direction parallel or planar to the pad surface, in a direction normal to the pad surface, or both, and may also be capable of sensing a level of pressure applied to the touch pad surface. The finger-operable interactive display may be formed of one or more translucent or transparent insulating layers and one or more translucent or transparent conducting layers. Edges of the interactive display may be formed to have a raised, indented, or roughened surface, so as to provide tactile feedback to a user when the user's fingers reach the edge, or other area, of the finger-operable interactive display screen 355.

The portable computing device 350 may also be configured to receive user input in various ways, in addition or in the alternative to user input received via user gestures. For example, the CPU 351 may be configured to implement a speech-to-text process and utilize a syntax that maps certain spoken commands to certain actions. In addition, the portable computing device 350 may include one or more microphones via which a user's speech may be captured. Configured as such, the computing device may be operable to detect spoken commands and carry out various computing functions that correspond to the spoken commands. The personal computing device 350 may include a central processing unit (CPU) 351, one or more data storage memories 354, a global positioning system (GPS) 359, a digital image processing module 358, an augmented reality processing module 352, a user gesture processing module 353, and a wireless communications interface 356. The digital image processing module 358 may be configured to receive image data from a digital camera 357, process the image data, and send the processed image data to the CPU 351 for rendering or displaying on the interactive display screen 355. The augmented reality processing module 352 may be configured to run an augmented reality application that generates an augmented reality image including information relevant to the portion of the machine included in the digital image.

The portable computing device 350 includes at least one processor configured to determine a position and orientation of the augmented reality image relative to a target point that has been identified on the machine and that appears in the digital image. The at least one processor may be communicatively coupled with or included in the digital image processing module 358, the augmented reality processing module 352, the CPU 351, the GPS 359, and the wireless communications interface 356. The at least one processor is configured to receive information on the location of one or more target points associated with the particular machine for which the digital image is being captured and rendered on the interactive display screen 355. Information on the location of the one or more target points on the particular machine being observed may be input by a user, determined by a comparison of the digital image captured with the digital camera 357 to a database of digital images stored in the data storage memory 354, or retrieved from an external database via the wireless communications interface 356. Alternatives to the illustrated wireless communications interface 356 may include wired connections. For example, a communication link to the portable computing device 350 may be a wired serial bus such as a universal serial bus or a parallel bus. A wired connection may be a proprietary connection as well. The wireless communications interface 356 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The portable computing device 350 may be accessible via the Internet and may include a computing cluster associated with a particular web service (e.g., social-networking, photo sharing, address book, etc.).

The augmented reality application run by the augmented reality processing module 352 may overlay the augmented reality image on the digital image relative to the one or more identified target points in a relationship based on the determined position and orientation of the augmented reality image. The augmented reality image is thereby aligned with the digital image on the interactive display 18, and rendered in a form configured to provide additional useful information to the user. The additional information included as part of the augmented reality image may be information useful to a technician in identifying the location of a potential fault relative to various subsystems that are not readily visible in the digital image. The information may be real-time information provided by sensors located at different positions on the machine, as well as historical information, empirical information, and calculated information based on combinations of different types of information. The technician may employ the portable computing device 350 while performing inspection, routine maintenance, or servicing of the machine or other object. In other potential applications of the portable computing device 350, the additional information included in the augmented reality image may be useful to a customer (e.g., by identifying part numbers and prices for various components), a vendor (e.g., by identifying current inventories of particular parts), a job site foreman (e.g., by identifying the number of operating hours since the last service and other operating conditions experienced by the machine), or any other authorized party. The exemplary digital image rendered on the interactive display 18 in the embodiment of FIGS. 1 and 2 is the image of a portion of an earth moving machine such as a bulldozer. The exemplary augmented reality image overlaying the digital image is a representation of an electrical wiring harness that is part of the electrical system for the machine and that would be at least partially hidden from view in the digital image.

As shown in FIGS. 1 and 2, the exemplary representation of a wiring harness 32 rendered by the augmented reality processing module and overlaid on top of the digital image of the machine portion 22 may be positioned and oriented in the location of the actual wiring for the particular machine appearing in the digital image. The augmented reality image may also provide representations of various sensors 42, such as short-to-ground sensors, in the locations on the digital image where they are actually located in the wiring harness 32 for the machine. Real time information on the position and orientation of a machine being inspected, maintained, or serviced by a technician or other user operating the portable computing device 350 is obtained from the digital camera 357, the GPS 359, and the wireless communications interface 356. Additional real time information in the form of signals and diagnostic data such as diagnostic codes received from the sensors 42 via the wireless communications interface 356 or other inputs to the portable computing device 350 may also be processed by the augmented reality processing module 352 and the CPU 351, and included in the augmented reality image rendered and displayed on the interactive display screen 355.

The user gesture processing module 353 is associated with the interactive display screen 355 and configured to simultaneously select a corresponding magnification of the digital image and the overlaid augmented reality image rendered on the interactive display screen. As discussed above, various gestures of a user relative to the interactive display screen 355 include pinching two fingers together or moving the fingers apart while in contact with or close proximity to the interactive display screen 355. The user gesture processing module 353 may be configured to interpret different gestures in different ways. For example, pinching two fingers together may result in the magnification of both the digital image and the overlaid augmented reality image decreasing, resulting in the appearance of zooming away from the machine portion. Moving the two fingers apart may result in the magnification of both the digital image and the overlaid augmented reality image increasing, resulting in the appearance of zooming in closer to the machine portion. In other alternative embodiments, the gestures of pinching two fingers together and moving the fingers apart may have the opposite effect on magnification of the digital and augmented reality images. The user gesture processing module 353 is configured to coordinate the rendering of the digital image and the overlaid augmented reality image such that the two images are maintained in a consistent aligned relationship with each other as the magnification of both is changed by the user gestures. As a result, a user is able to zoom in on a small area of the machine portion 22 in the exemplary embodiment shown in FIGS. 1 and 2, while at the same time zooming in on the relevant portion of the wiring harness 32 that exists within that small area. A technician may begin an inspection by viewing a general area of the machine in the digital image on the interactive display 18, along with all associated wiring or other systems included in the overlaid augmented reality image. If a potentially problematic reading from a sensor 42 is identified at a particular location on the machine, the technician may then zoom in on that particular location in the digital image while the magnification of the representation in the augmented reality image is correspondingly increased.

In various alternative embodiments, the system, feature or characteristic of the portion of the machine represented in the augmented reality image may include at least one of an electrical circuit, a hydraulic circuit, a pneumatic circuit, and a diagnostic code or signal received in real time from a sensor associated with the portion of the machine seen in the digital image. The augmented reality image may also include various alarms or other indicators designed to highlight areas that may need maintenance or servicing. In some implementations the augmented reality image may include a flashing indicator of a diagnostic code or sensor reading indicative of a recommended maintenance protocol. Diagnostic data or codes may flash on the augmented reality image when the detected, measured, or calculated values fall outside of a predetermined acceptable range of values. The flashing indicator provided as part of the augmented reality image is superimposed over the digital image at the location on the portion of the machine where the code or sensor reading originated, or where the measured results will be applicable.

The exemplary portable computing device 350 shown in FIG. 3 further includes one or more memories such as the data storage memory 354, and the augmented reality processing module 352 may be configured to generate the augmented reality image based on information retrieved from the data storage memory 354 for a particular type, model, or serial number of the machine. The type, model, or serial number of a machine may be identified by at least one of a user input or a comparison performed by the CPU 351 between the digital image and a database of digital images for different types, models, and serial numbers of the machine. The augmented reality processing module 352 is also configured to determine the position and orientation of the augmented reality image relative to a target point identified on the machine and appearing in the digital image. Target points may be one or more readily identifiable features on the machine that are easily recognized and located by the augmented reality application from the digital image. In various exemplary implementations of this disclosure the augmented reality processing module may be configured to retrieve stored information relevant to the machine from an external source using a wireless communications interface on the computing device. The stored information may include historical data for exactly the same machine being viewed, general data or information for the same type or model of machine, and manufacturer information pertinent to the machine.

The ability of the disclosed portable computing device to maintain the proper relationship between the digital image and the overlaid augmented reality image as a user simultaneously changes the magnification of both images with simple gestures relative to the interactive display screen 355 provides an intuitive experience for the user. An exemplary implementation of a method for using a portable computing device according to the disclosed embodiments is discussed in the following section.

### INDUSTRIAL APPLICABILITY

The disclosed portable computing device may be applicable to the inspection, maintenance, and servicing of any machine that includes features observable in a digital image of the machine captured and rendered by the computing device. The disclosed computing device also displays additional features, systems, characteristics, or information associated with the observable features, which may be overlaid on the digital image as an augmented reality image. The disclosed computing device may assist a user with relating sensory data or other pertinent information to specific locations on the machine that correspond to a source of the information or are otherwise associated with the information. Examples of the types of information that may be included in an augmented reality image overlaid on a digital image of a portion of a machine may include representations of non-visible subsystems such as electrical wiring, hydraulic lines, or pneumatic lines, diagnostic codes and other diagnostic data relevant to the observed portion of the machine, part numbers or other identifying information related to the features visible in the digital image, and relevant maintenance procedures and protocols. The operation of an exemplary embodiment of the computing device will now be explained.

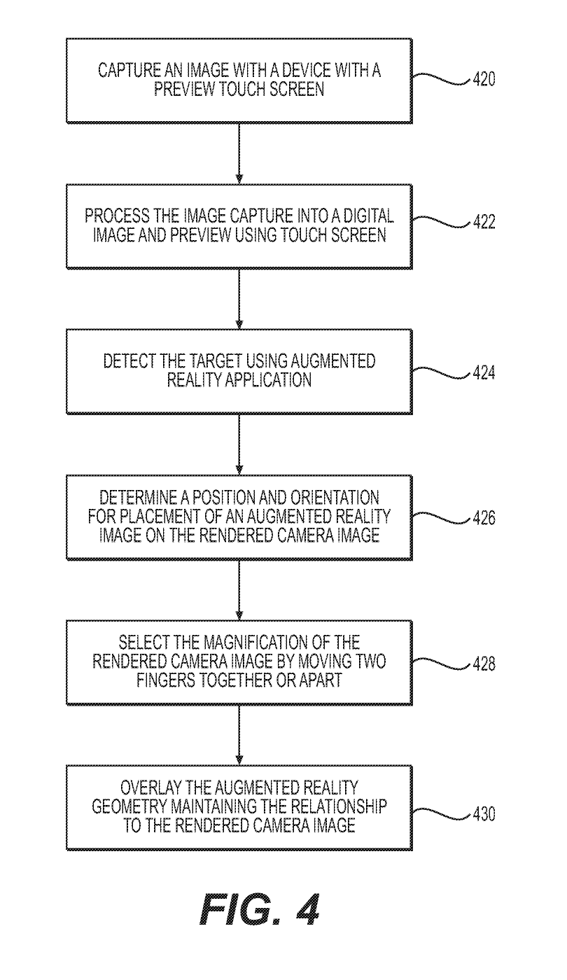

The flowchart in FIG. 4 shows functionality and operation of one possible implementation of an exemplary embodiment of the disclosed computing device, such as the exemplary embodiment illustrated in FIGS. 1-3. In this regard, each block in FIG. 4 may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, and compact-disc read only memory (CD-ROM), for example. The computer readable medium may also be any other volatile or non-volatile storage systems.

At Step: 420, a portable computing device, such as the portable computing device 350 shown in FIG. 3, may capture a digital image of a portion of a machine or other object being inspected or serviced using a digital camera 357 mounted on the device. The digital image processing module 358 may then process the image that is captured by the camera 357 at Step: 422, and in conjunction with the CPU 351, display a digital image on the interactive display screen 355 of the portable computing device 350.

At Step: 424, the augmented reality processing module 352 may run an augmented reality application to detect a target point on the machine or object as it appears in the digital image. The augmented reality processing module 352 may receive relevant information for the machine from the data storage memory 354, the GPS 359, and from other sources of information accessed using the wireless communications interface 356. This relevant information may include the precise location of known target points on various models or types of machines that will be inspected and/or serviced using the portable computing device 350. A target point may be a special symbol or trigger mark on the object that is identified by the augmented reality application when the camera 357 of the portable computing device 350 is pointed at that portion of the object. The detected target point then serves as a reference point from which the augmented reality application can determine a position and orientation for placement of an augmented reality image on the rendered digital image at Step: 426. As a result, pointing the camera 357 of the portable computing device 350 at the portion of the object including the identifiable target point automatically results in the augmented reality image being overlaid in the proper relationship with the digital image to provide the user with an accurate indication of augmented features, characteristics, and information that could not otherwise be directly observed by viewing the digital image of the object.

After the augmented reality image is overlaid on the digital image on the interactive display screen 355, the user gesture processing module 353 recognizes various user gestures, such as moving two fingers together or apart while in contact with or close proximity to the interactive display screen. At Step: 428, a user may perform the recognized gestures in order to select the magnification of the rendered digital image. In some implementations pinching two fingers together on the interactive display may zoom out from the digital image, while moving the two fingers apart on the interactive display may zoom in on the digital image. Simultaneously with the effect of changing magnification of the digital image by pinching to zoom out and spreading the fingers to zoom in on the digital image, at Step: 430, the gesture processing module 357 also causes the geometry of the augmented reality image overlaid on the digital image to change magnification and maintain the same relationship with the digital image. As a result, a user who wants to zoom in on a particular area of a machine or other object can simultaneously view a more magnified digital image of that particular area and a more magnified view of the augmented features, characteristics, and information associated with that particular area. Similarly, zooming out to view a more generalized overview of a larger area of the machine or object results in a less magnified digital image of the larger area and a less magnified, more generalized overview of the augmented features, characteristics, and information associated with the larger area.

It will be apparent to those skilled in the art that various modifications and variations can be made to the disclosed computing device. Other embodiments will be apparent to those skilled in the art from consideration of the specification and practice of the disclosed computing device. It is intended that the specification and examples be considered as exemplary only, with a true scope being indicated by the following claims and their equivalents.

1. A computing device configured for use during inspection and maintenance of a machine, the computing device comprising:
a central processing unit (CPU);
a digital camera communicatively coupled with the CPU and configured to capture a digital image of at least a portion of the machine and send the digital image to the CPU for processing;
an interactive display communicatively coupled with the digital camera and the CPU and configured to render the digital image;
an augmented reality processing module communicatively coupled with the CPU and the interactive display, the augmented reality processing module being configured to:
detect a target point located on the machine and appearing within the digital image;
generate an augmented reality image including information relevant to the portion of the machine included in the digital image;
determine a position and orientation of the augmented reality image relative to the target point; and
cause an overlay of the augmented reality image on the digital image relative to the target point in a relationship based on the determined position and orientation automatically upon pointing of the digital camera at the portion of the machine including the detected target point; and
a user gesture processing module associated with the interactive display and configured to select a corresponding magnification of the digital image and the overlaid augmented reality image displayed on the interactive display based on a user gesture relative to the interactive display while maintaining the relationship between the digital image and the augmented reality image.

2. The computing device of claim 1, wherein the user gesture processing module is configured to maintain a consistent, aligned relationship between the digital image and the overlaid augmented reality image displayed on the interactive display as a magnification of both the digital image and the overlaid augmented reality image is changed by the user gesture.

3. The computing device of claim 2, wherein the user gesture includes at least one of moving two fingers together and apart in contact with or in close proximity to the interactive display.

4. The computing device of claim 1, wherein the augmented reality image includes a representation of at least one of a system, a feature, or a characteristic associated with the portion of the machine, and provides additional information to augment the digital image.

5. The computing device of claim 4, wherein the at least one system, feature or characteristic of the portion of the machine includes at least one of an electrical circuit, a hydraulic circuit, a pneumatic circuit, and a diagnostic code or signal received in real time from a sensor associated with the portion of the machine seen in the digital image.

6. The computing device of claim 5, wherein the augmented reality image includes a flashing indicator of a diagnostic code or sensor reading indicative of a recommended maintenance protocol, and wherein the flashing indicator is superimposed over the digital image at a location on the portion of the machine where the diagnostic code or sensor reading applies.

7. The computing device of claim 1, further including a data storage memory, and wherein the augmented reality processing module is further configured to generate the augmented reality image based on information retrieved from the data storage memory for a particular type or model of the machine identified by at least one of a user or a comparison performed by the CPU between the digital image and a database of digital images for different types or models of the machine.

8. The computing device of claim 1, wherein the augmented reality processing module is further configured to determine the position and orientation of the augmented reality image relative to the target point by retrieving stored information relevant to the machine from an external source using a wireless communications interface on the computing device.

9. The computing device of claim 1, wherein the augmented reality image includes a real-time representation of at least one of a system, a feature, or a characteristic of the portion of the machine captured in the digital image and conveying real-time information to a user to assist in the inspection and maintenance of the machine.

10. A client computing device, comprising:
an interactive display;
a digital camera communicatively coupled with the interactive display;
at least one processor; and
at least one memory including computer program code for one or more programs;
the at least one memory and the computer program code configured to, with the at least one processor, cause the client computing device to:
display a digital image of at least a portion of a product on the interactive display;
zoom in and zoom out on the digital image based on gestures of a user relative to the interactive display;
generate an augmented reality image including information relevant to and aligned with specific locations on the digital image;
cause an overlay of the augmented reality image on the digital image automatically upon pointing of the digital camera at the portion of the product including the specific locations on the digital image; and
maintain alignment between the digital image and the information of the augmented reality image and correlate magnification of the digital image with magnification of the augmented reality image while a user zooms in and out on the digital image of the product using the gestures relative to the interactive display.

11. The client computing device of claim 10, wherein the memory and the computer program code are configured to, with the at least one processor, cause the client computing device to display the digital image of at least a portion of a product at which the digital camera on the client computing device is aimed.

12. The client computing device of claim 10, wherein the memory and the computer program code are configured to, with the at least one processor, cause the client computing device to generate an augmented reality image including diagnostic data associated with signals produced by one or more sensors located on the product at the specific locations on the digital image.

13. The client computing device of claim 12, wherein the memory and the computer program code are configured to, with the at least one processor, cause the client computing device to generate the augmented reality image including the diagnostic data flashing at the specific locations on the digital image when the diagnostic data is indicative of a recommended maintenance protocol.

14. The client computing device of claim 12, wherein the memory and the computer program code are configured to, with the at least one processor, cause the client computing device to generate the augmented reality image including the diagnostic data flashing at the specific locations on the digital image when the diagnostic data falls outside of a predetermined acceptable range of values for a characteristic of the product being measured by the one or more sensors.

15. The client computing device of claim 10, wherein the interactive display, the digital camera, the at least one memory, and the at least one processor are included in at least one of a tablet device, a smartphone, and a laptop computer.

16. The client computing device of claim 10, wherein the gestures of the user relative to the interactive display include at least one of pinching two fingers together to simultaneously zoom out on the digital image and the augmented reality image, and moving two fingers apart to simultaneously zoom in on the digital image and the augmented reality image.

17. A method of inspecting and maintaining a machine using a computing device, wherein the computing device includes an interactive display, a digital camera communicatively coupled with the interactive display, at least one processor, and at least one memory including computer program code for one or more programs, the method comprising:
the at least one processor retrieving stored information from the at least one memory and using the stored information along with the computer program code to cause the computing device to:
display a digital image of at least a portion of the machine on the interactive display;
zoom in and zoom out on the digital image based on gestures of a user relative to the interactive display;
generate an augmented reality image including information relevant to and aligned with specific locations on the digital image;
cause an overlay of the augmented reality image on the digital image automatically upon pointing of the digital camera at the portion of the machine including the specific locations on the digital image; and
maintain alignment between the digital image and the information of the augmented reality image and correlate magnification of the digital image with magnification of the augmented reality image while a user zooms in and out on the digital image of the machine using the gestures relative to the interactive display.

18. The method of claim 17, wherein the at least one processor causes the computing device to display the digital image of at least a portion of the machine at which the digital camera on the computing device is aimed.

19. The method of claim 17, wherein the at least one processor causes the computing device to generate an augmented reality image including diagnostic data associated with signals produced by one or more sensors located on the machine at the specific locations on the digital image.

20. The method of claim 19, wherein the at least one processor causes the computing device to generate the augmented reality image including the diagnostic data flashing or otherwise changing appearance at the specific locations on the digital image when the diagnostic data is indicative of a recommended maintenance protocol.
